(19) United States
(12) Patent Application Publication
(10) Pub. No.: US 2025/0091578 A1
(43) Pub. Date: Mar. 20, 2025

(54) VEHICLE CONTROL DEVICE

(71) Applicant: HONDA MOTOR CO., LTD., Tokyo (JP)

(72) Inventors: Takashi AMANO, Tokyo (JP); Kazuki TOMIOKA, Tokyo (JP); Yoshimitsu MURAHASHI, Tokyo (JP)

(73) Assignee: HONDA MOTOR CO., LTD., Tokyo (JP)

(21) Appl. No.: 18/808,083

(22) Filed: Aug. 19, 2024

(30) Foreign Application Priority Data
Sep. 20, 2023 (JP) 2023-152159

(51) Int. Cl. B60W 30/16; B60W 30/14; B60W 30/18; B60W 50/00

(52) U.S. Cl. CPC B60W 30/16; B60W 30/143; B60W 30/18163; B60W 50/0097; B60W 2520/105; B60W 2554/4042; B60W 2554/802

(57) ABSTRACT

A control device of a vehicle includes a processor. The processor is configured to obtain a traveling angle of a preceding vehicle relative to a traveling direction of the vehicle, the preceding vehicle being followed by the vehicle, and the processor is configured to control an inter-vehicle distance between the vehicle and the preceding vehicle based on the traveling angle.

### CROSS-REFERENCE TO RELATED APPLICATIONS

This application is based on and claims priority under 35 USC 119 from Japanese Patent Application No. 2023-152159 filed on Sep. 20, 2023, the contents of which are incorporated herein by reference.

### TECHNICAL FIELD

The present disclosure relates to a control device for a vehicle.

### BACKGROUND

In recent years, efforts have been actively made to provide access to a sustainable transportation system in consideration of vulnerable people among traffic participants. In order to implement the above, focus has been placed on research and development on further improving safety and convenience of traffic by research and development related to driving assistance techniques. Driving assistance techniques include, for example, those disclosed in Patent Literature 1-4.

Patent Literature 1 (Japanese Patent Application Laid-Open Publication No. 2023-010320) describes an automated driving method of: releasing acceleration limit for causing the host vehicle to follow a preceding vehicle if it is detected that an intent indication of lane change to an adjacent lane is sent from the preceding vehicle, and if it is detected that the preceding vehicle has left toward the adjacent lane.

Patent Literature 2 (Japanese Patent Application Laid-Open Publication No. 2006-182259) discloses a travel control device including: an inter-vehicle distance detection unit for detecting an inter-vehicle distance from a preceding vehicle; a host vehicle speed detection unit for detecting a host vehicle speed; and a following control unit for following the preceding vehicle so that the inter-vehicle distance from the preceding vehicle is a target inter-vehicle distance. The travel control device includes: a first following control mode of following the preceding vehicle until the preceding vehicle stops; and a second following control mode of following the preceding vehicle until the host vehicle speed falls to a predetermined low vehicle speed greater than 0.

Patent Literature 3 (Japanese Patent Application Laid-Open Publication No. 2016-147556) discloses a driving control device for a vehicle having a function of traveling while maintaining a set inter-vehicle distance from a preceding vehicle. The driving control device: detects a target vehicle in a positional correlation that can cut in between the host vehicle and the preceding vehicle among other vehicles traveling in a lane adjacent to a lane in which the host vehicle travels; and changes the inter-vehicle distance if a warning state in which the target vehicle may cut in is detected.

Patent Literature 4 (Japanese Patent Application Laid-Open Publication No. 2019-131077) discloses a vehicle control device including: a recognition unit for recognizing a surrounding situation of a host vehicle; and an operation control unit for controlling acceleration or deceleration and steering of the host vehicle based on a recognition result by the recognition unit. If the host vehicle passes through an intersection, and if a planned traveling direction of the host vehicle is a direction passing through the intersection across a course of an oncoming vehicle and a central separation band is present on a road on which the host vehicle travels, the driving control unit performs travel control in response to a behavior of a preceding vehicle estimated as having an intent to travel in the planned direction in front of the host vehicle, thereby causing the host vehicle to follow the preceding vehicle and pass through the intersection.

If the driving force of the vehicle is controlled on the system side, it is required to perform the control without causing the driver to feel discomfort.

The present disclosure provides a control device that can improve the satisfaction of the driver by appropriately controlling the driving force.

This contributes to development of a sustainable transportation system.

### SUMMARY

An aspect of the present disclosure relates to a control device of a vehicle including a processor. The processor is configured to obtain a traveling angle of a preceding vehicle relative to a traveling direction of the vehicle, the preceding vehicle being followed by the vehicle, and the processor is configured to control an inter-vehicle distance between the vehicle and the preceding vehicle based on the traveling angle.

### BRIEF DESCRIPTION OF DRAWINGS

Exemplary embodiments of the present invention will be described in detail based on the following figures, wherein

FIG. 1 is a diagram illustrating a vehicle 1 controlled by a control device according to an embodiment of the technique of the present disclosure;

FIG. 2 is a flowchart illustrating the processing of a control device 30 in following travel control;

FIG. 3 is a schematic diagram (part 1) illustrating an operation when a preceding vehicle 1A enters a facility while a vehicle 1 is following the preceding vehicle 1A;

FIG. 4 is a schematic diagram (part 2) illustrating an operation when the preceding vehicle 1A enters the facility while the vehicle 1 is following the preceding vehicle 1A;

FIG. 5 is a flowchart illustrating a preferred example of the processing of the control device 30 in the following travel control; and

FIG. 6 is a flowchart illustrating another preferred example of the processing of the control device 30 in the following travel control.

### DESCRIPTION OF EMBODIMENTS

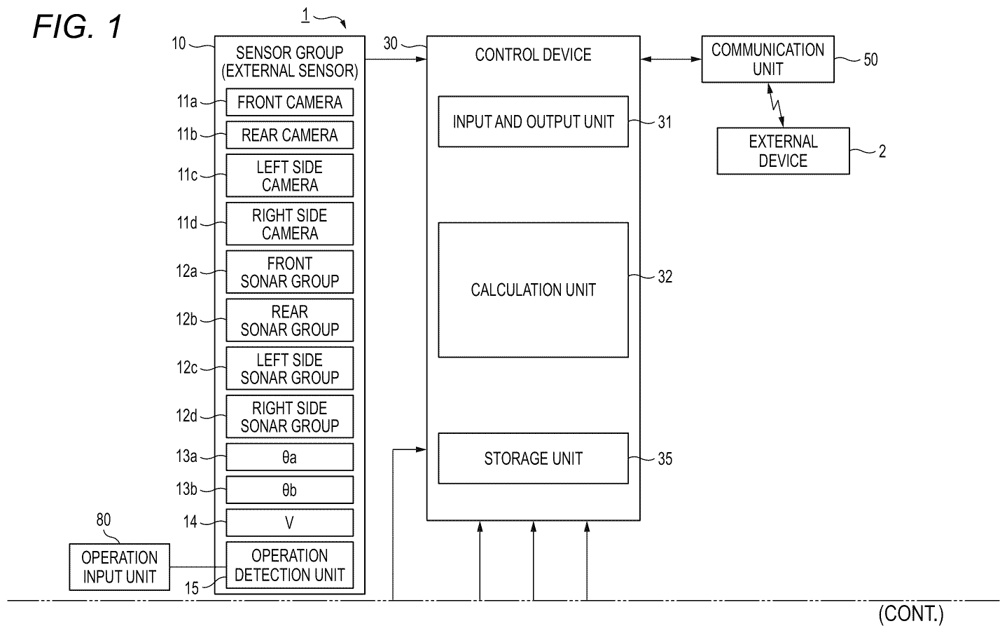

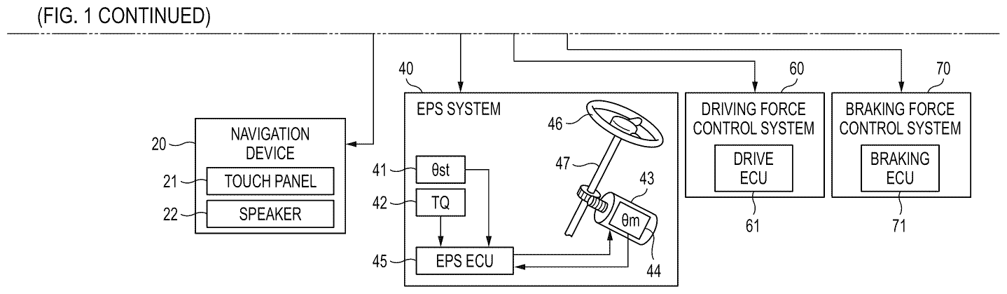

FIG. 1 is a diagram illustrating a vehicle 1 controlled by a control device according to an embodiment of the technique of the present disclosure. The vehicle 1 illustrated in FIG. 1 is an automobile including a drive source, and wheels (none illustrated) including drive wheels driven by power of the drive source and driven wheels that can be steered. For example, the vehicle 1 is a four-wheeled automobile including a pair of left and right front wheels and a pair of left and right rear wheels.

The drive source of the vehicle 1 may be an electric motor, an internal combustion engine such as a gasoline engine or a diesel engine, or a combination of the electric motor and the internal combustion engine. Further, the drive source of the vehicle 1 may drive the pair of left and right front wheels, the pair of left and right rear wheels, or the four wheels including the pair of left and right front wheels and the pair of left and right rear wheels. Any one of the front wheels and the rear wheels may be driven wheels that can be steered, or both of the front wheels and the rear wheels may be driven wheels that can be steered.

As illustrated in FIG. 1, the vehicle 1 includes a sensor group 10, a navigation device 20, a control device 30, an EPS system (electric power steering system) 40, a communication unit 50, a driving force control system 60, a braking force control system 70, and an operation input unit 80.

The sensor group 10 obtains various detection values related to the vehicle 1 or a periphery of the vehicle 1. The detection values obtained by the sensor group 10 are sent to the control device 30 and used for the travel control of the vehicle 1 and the like.

The sensor group 10 includes, for example, a front camera 11a, a rear camera 11b, a left side camera 11c, a right side camera 11d, a front sonar group 12a, a rear sonar group 12b, a left side sonar group 12c, and a right side sonar group 12d. The camera group and the sonar group can function as external sensors that obtain peripheral information on the vehicle 1.

The front camera 11a, the rear camera 11b, the left side camera 11c, and the right side camera 11d output image data of peripheral images obtained by imaging the periphery of the vehicle 1 to the control device 30. The peripheral images captured by the front camera 11a, the rear camera 11b, the left side camera 11c, and the right side camera 11d are also referred to as a front image, a rear image, a left side image, and a right side image. Further, an image constituted by the left side image and the right side image is also referred to as a side image.

The front sonar group 12a, the rear sonar group 12b, the left side sonar group 12c, and the right side sonar group 12d emit sound waves to the periphery of the vehicle 1, and receive reflected sounds from another object. The front sonar group 12a includes, for example, four sonars. The sonars that constitute the front sonar group 12a are provided on an obliquely left front side, a front left side, a front right side, and an obliquely right front side of the vehicle 1. The rear sonar group 12b includes, for example, four sonars. The sonars that constitute the rear sonar group 12b are provided on an obliquely left rear side, a rear left side, a rear right side, and an obliquely right rear side of the vehicle 1. The left side sonar group 12c includes, for example, two sonars. The sonars that constitute the left side sonar group 12c are provided on a left front side and a left rear side of the vehicle 1. The right side sonar group 12d includes, for example, two sonars. The sonars that constitute the right side sonar group 12d are provided on a right front side and a right rear side of the vehicle 1.

The sensor group 10 further includes wheel sensors 13a and 13b, a vehicle speed sensor 14, and an operation detection unit 15. The wheel sensors 13a and 13b detect rotation angles θa and θb of the wheels (not illustrated). The wheel sensors 13a and 13b may be implemented by angle sensors or displacement sensors. The wheel sensors 13a and 13b output detection pulses every time the wheels are rotated by a predetermined angle. The detection pulses output from the wheel sensors 13a and 13b can be used for calculating a rotation angle of the wheels and a rotation speed of the wheels. A movement distance of the vehicle 1 can be calculated based on the rotation angle of the wheels. The wheel sensor 13a detects, for example, the rotation angle θa of the left rear wheel. The wheel sensor 13b detects, for example, the rotation angle θb of the right rear wheel.

The vehicle speed sensor 14 detects a travel speed of a vehicle body (not illustrated) of the vehicle 1, that is, a vehicle speed V, and outputs the detected vehicle speed V to the control device 30. The vehicle speed sensor 14 detects the vehicle speed V based on, for example, rotation of a transmission countershaft.

The operation detection unit 15 detects an operation content of a driver performed using the operation input unit 80, and outputs the detected operation content to the control device 30. The operation input unit 80 may include, for example, an operation button or the like that receives an operation for executing various modes of driving assistance. The operation input unit 80 and a touch panel 21, which will be described later, may be made common.

The navigation device 20 detects a current position of the vehicle 1 by using, for example, a global positioning system (GPS), and guides the driver a path to a destination. The navigation device 20 includes a storage device (not illustrated) provided with a map information database. The map information database includes position information on various facilities where many traffic participants such as people and cars enter and exit, such as a department store, a supermarket, a convenience store, a restaurant, a gasoline stand, a parking lot, a company, a factory, and a school.

The navigation device 20 includes a touch panel 21 integrated with a display device and a speaker 22. The touch panel 21 functions as an input device that receives input of various types of information to the control device 30 and as a display device controlled by the control device 30. That is, the driver may input various commands to the control device 30 via the touch panel 21. Various screens are displayed on the display device integrated with the touch panel 21.

The speaker 22 outputs various types of guidance information to the driver by a sound.

The control device 30 is a device (computer) that generally controls the entire vehicle 1. The control device 30 includes, for example, an input and output unit 31, a calculation unit 32, and a storage unit 35. The input and output unit 31 is an interface that inputs and outputs data between inside and outside of the control device 30 under control of the calculation unit 32. The storage unit 35 includes, for example, a non-volatile storage medium such as a flash memory, and stores various information (for example, data and programs) for controlling an operation of the vehicle 1.

The calculation unit 32 is implemented by a processor such as a central processing unit (CPU), and controls each element of the vehicle 1 by executing the programs stored in the storage unit 35 or the like. The calculation unit 32 performs following travel control for causing the vehicle 1 to travel following another vehicle traveling in front of the vehicle 1 (hereinafter referred to as a preceding vehicle) while maintaining a constant inter-vehicle distance L with the preceding vehicle. The calculation unit 32 recognizes the preceding vehicle based on image data of a peripheral image obtained from the sensor group 10, and controls the driving force of the vehicle 1 to maintain a constant inter-vehicle distance from the recognized preceding vehicle. The calculation unit 32 recognizes, as a preceding vehicle, a vehicle that is present, for example, on a predicted travel path in front of the vehicle 1 and in a predetermined travel area recognized as a preceding vehicle.

In the following travel control, the driving force is controlled such that the inter-vehicle distance L between the vehicle 1 and the preceding vehicle becomes one of a plurality of set values. In the following description, the inter-vehicle distance L includes, for example, four control values: a set value A1, a set value A2, a set value A3, and a set value A4. The magnitude correlation between the four set values is the set value A1<the set value A2<the set value A3<the set value A4.

The EPS system 40 includes a steering angle sensor 41, a torque sensor 42, an EPS motor 43, a resolver 44, and an EPS electronic control unit (EPS ECU) 45. The steering angle sensor 41 detects a steering angle θst of a steering 46. The torque sensor 42 detects a torque TQ applied to the steering 46.

The EPS motor 43 applies a driving force or a reaction force to a steering column 47 connected to the steering 46, thereby enabling assistance of an operation performed by the driver on the steering 46 and enabling automated steering. The resolver 44 detects a rotation angle θm of the EPS motor 43. The EPS ECU 45 controls the entire EPS system 40. The EPS ECU 45 includes an input and output unit, a calculation unit, and a storage unit (none illustrated).

The communication unit 50 is a communication interface that communicates with the external device 2 separate from the vehicle 1 under control of the control device 30. The control device 30 may communicate with the external device 2 via the communication unit 50. For example, a mobile communication network such as a cellular line, WI-FI (registered trademark), or Bluetooth (registered trademark) may be adopted for the communication between the vehicle 1 and the external device 2. The external device 2 may be managed by, for example, a manufacturer of the vehicle 1.

The driving force control system 60 includes a drive ECU 61. The driving force control system 60 executes driving force control of the vehicle 1. The drive ECU 61 controls a driving force of the vehicle 1 (including the acceleration) by controlling an engine, a motor, or the like (not illustrated) based on an operation performed on an accelerator pedal (not illustrated) by the driver or an instruction from the control device 30. The drive ECU 61 includes an input and output unit, a calculation unit, and a storage unit (none illustrated).

The braking force control system 70 includes a braking ECU 71. The braking force control system 70 executes braking force control of the vehicle 1. The braking ECU 71 controls a braking force to the vehicle 1 by controlling a brake mechanism or the like (not illustrated) based on an operation on a brake pedal (not illustrated) by the driver. The braking ECU 71 includes an input and output unit, a calculation unit, and a storage unit (none illustrated).

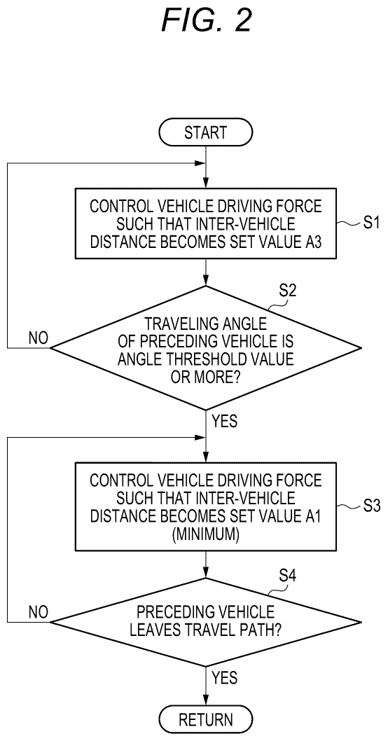

FIG. 2 is a flowchart illustrating the processing of the control device 30 in the following travel control. When the mode of the following travel control is set, the calculation unit 32 sets the control value of the inter-vehicle distance L to a default value or a value selected by the driver. For example, the calculation unit 32 sets the control value of the inter-vehicle distance to the set value A3, recognizes the preceding vehicle and the travel state thereof based on the image data of the peripheral image and the detection information of the front sonar group 12a, and controls the driving force of the vehicle 1 such that the inter-vehicle distance L between the preceding vehicle and the vehicle 1 becomes the set value A3 in accordance with the travel state (step S1). Hereinafter, the preceding vehicle will be referred to as a preceding vehicle 1A.

During the control such that the inter-vehicle distance L to the preceding vehicle 1A becomes the set value A3, the calculation unit 32 obtains the traveling angle of the preceding vehicle 1A relative to the traveling direction of the vehicle 1, and determines whether the obtained traveling angle is equal to or greater than an angle threshold (step S2). The calculation unit 32 recognizes, for example, the traveling direction of the vehicle 1 and the traveling direction of the preceding vehicle 1A, and derives the angle between the two traveling directions as the traveling angle. Further, the calculation unit 32 recognizes, for example, the lane of the travel path of the vehicle 1 and derives the angle of the traveling direction of the preceding vehicle relative to the lane as the traveling angle.

The angle threshold used in the determination of step S2 is set to, for example, the minimum value of the magnitude of the traveling angle that can be reached if a vehicle traveling on a travel path turns left to enter a facility adjacent to the travel path, and is set to a magnitude that cannot be reached if a vehicle performs lane change to move to an adjacent travel path or if the lane temporarily meanders to dodge an obstacle in the travel path.

If the determination of step S2 is NO, the calculation unit 32 continues the processing of step S1. If the determination of step S2 is YES, the calculation unit 32 controls the driving force of the vehicle 1 such that the inter-vehicle distance L becomes the minimum value (here, the set value A1) of the plurality of set values (the set value A1, the set value A2, the set value A3, and the set value A4) (step S3). That is, in step S3, the control value of the inter-vehicle distance L is changed from the set value A3 selected in advance to the minimum set value A1.

After step S3, the calculation unit 32 determines whether the preceding vehicle 1A leaves the travel path (step S4). For example, if the preceding vehicle 1A entirely falls out of the lane of the travel path (out of the travel path if there is no lane) based on the image data of the peripheral image or the like, the calculation unit 32 determines that the preceding vehicle 1A leaves the travel path.

The calculation unit 32 continues the processing of step S3 if the determination of step S4 is NO, and returns to the processing of step S1 if the determination of step S4 is YES. That is, in this case, the control value of the inter-vehicle distance L returns from the set value A1 to the original set value A3.

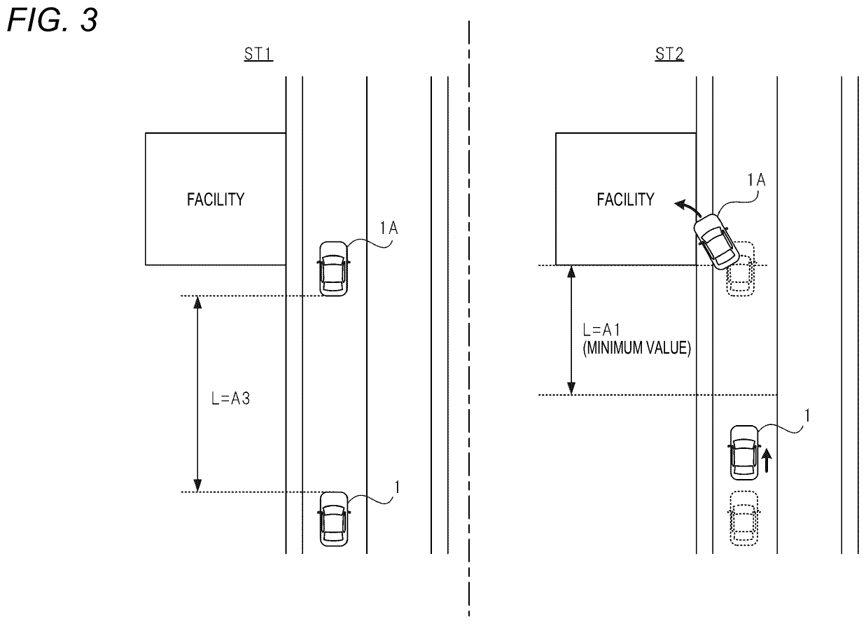

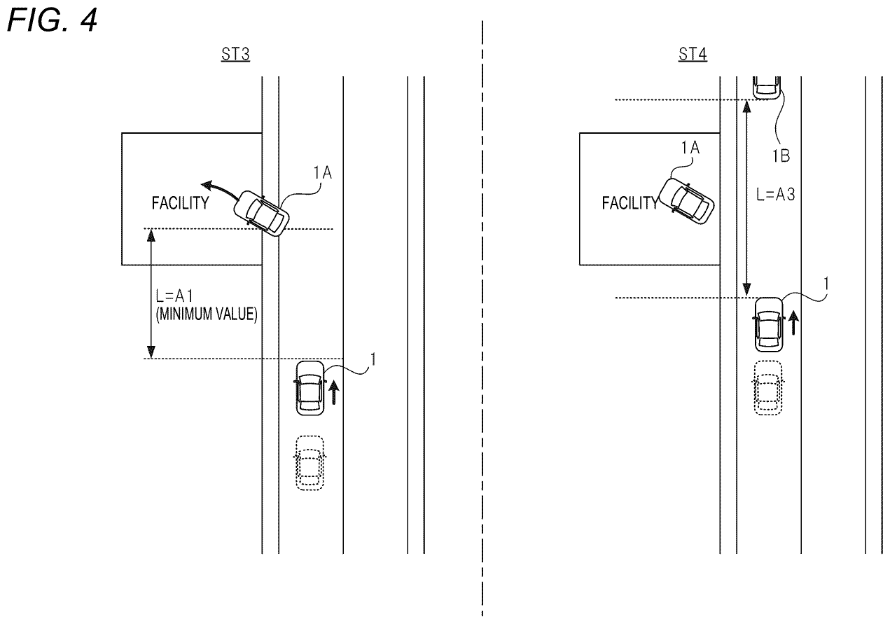

FIGS. 3 and 4 are schematic diagrams illustrating an operation when the preceding vehicle 1A enters the facility while the vehicle 1 is following the preceding vehicle 1A. A state ST1 in FIG. 3 illustrates a state in which the preceding vehicle 1A is temporarily stopped to enter the facility. In the state ST1, since the control value of the inter-vehicle distance Lis the set value A3, the vehicle 1 is also stopped with the inter-vehicle distance L being the set value A3.

A state ST2 in FIG. 3 illustrates a state in which the preceding vehicle 1A starts turning left from the state ST1 to enter the facility. When the preceding vehicle 1A starts turning left, the traveling angle of the preceding vehicle 1A is equal to or greater than the angle threshold. Therefore, the control value of the inter-vehicle distance L is changed from the set value A3 to the set value A1. As a result, the vehicle 1 approaches the preceding vehicle 1A relative to the state ST1 to reduce the inter-vehicle distance L to the set value A1.

The state ST3 of FIG. 4 illustrates a state in which the preceding vehicle 1A and the vehicle 1 further advance from the state ST2. The state ST4 in FIG. 4 illustrates a state in which the preceding vehicle 1A further advances from the state ST3 and the preceding vehicle 1A leaves the travel path. In the state ST4, the control value of the inter-vehicle distance Lis changed from the set value A1 to the set value A3. The calculation unit 32 of the vehicle 1 recognizes a new preceding vehicle 1B and controls the driving force of the vehicle 1 such that the inter-vehicle distance to the preceding vehicle 1B becomes the set value A3.

In the state ST2 of FIG. 3, it is assumed that the control value of the inter-vehicle distance L is maintained at the set value A3. In this case, the vehicle 1 remains stopped until the preceding vehicle 1A leaves the travel path. On the other hand, according to the processing of FIG. 2, the vehicle 1 can gradually approach the preceding vehicle 1A while the preceding vehicle 1A is entering the facility. As a result, the time for the vehicle 1 to stop can be shortened, and the timing for the vehicle 1 to re-accelerate after being stopped can be advanced, thereby enabling natural travel control close to the sense of manual driving. Further, according to the processing of FIG. 2, if the preceding vehicle 1A changes lanes or meanders to dodge an obstacle, the determination of step S2 is NO, and the control value of the inter-vehicle distance L is held at the set value A3. In this way, the inter-vehicle distance L is not changed more than necessary, thereby enabling natural travel control without discomfort.

In the state ST3 of FIG. 4, for example, if it is recognized that another vehicle is present on the planned travel route of the preceding vehicle 1A based on the image data of the peripheral image or the like, the calculation unit 32 preferably stops the vehicle 1 at a position where the inter-vehicle distance L from the preceding vehicle 1A is the set value A1.

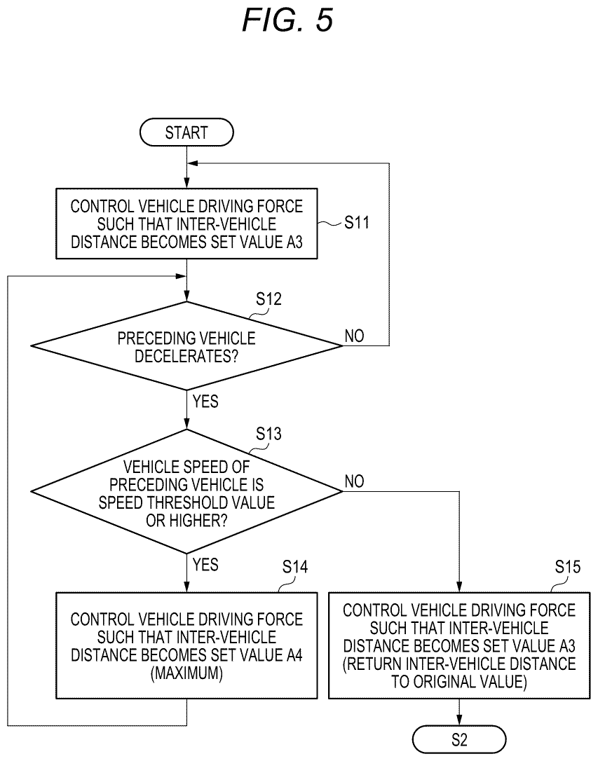

FIG. 5 is a flowchart illustrating a preferred example of the processing of the control device 30 in the following travel control. When the mode of following travel control is set, the calculation unit 32 performs the same processing as step S1 of FIG. 2 (step S11).

The calculation unit 32 determines whether the preceding vehicle 1A decelerates based on the detection information of the sonar group included in the sensor group 10 or the like (step S12). If the determination of step S12 is NO, the processing of step S11 is continued. If the determination of step S12 is YES, the calculation unit 32 determines whether the vehicle speed of the preceding vehicle 1A is equal to or higher than the speed threshold (step S13).

If the determination of step S13 is YES, it can be determined that the preceding vehicle 1A may have started decelerating to enter the facility. In this case, the calculation unit 32 controls the driving force of the vehicle 1 such that the inter-vehicle distance L becomes the maximum value (here, the set value A4) of the plurality of set values (the set value A1, the set value A2, the set value A3, and the set value A4) in preparation for the preceding vehicle 1A to enter the facility (Step S14). That is, in step S14, the control value of the inter-vehicle distance L is changed from the set value A3 to the set value A4. After step S14, the processing proceeds to step S12.

After the preceding vehicle 1A starts decelerating to enter the facility, if the preceding vehicle 1A approaches the facility and the speed of the preceding vehicle 1A decreases sufficiently, the determination of step S13 is NO. If the determination of step S13 is NO, the calculation unit 32 controls the driving force of the vehicle 1 such that the inter-vehicle distance L becomes the set value A3 (step S15). That is, in step S15, the control value of the inter-vehicle distance L is returned from the set value A4 to the original set value A3. After step S15, the processing from step S2 in FIG. 2 is performed.

According to the processing illustrated in FIG. 5, at the stage where the preceding vehicle 1A starts to decelerate to turn left to the facility, the inter-vehicle distance Lis controlled to be the maximum value. This can shorten the time thereafter for the vehicle 1 to stop before the preceding vehicle 1A starts turning left and leaves the travel path. As a result, the vehicle 1 can be smoothly accelerated after the preceding vehicle 1A leaves the travel path. In addition, if the preceding vehicle 1A decelerates to enter the facility, the inter-vehicle distance L to the vehicle 1 is gradually reduced in response to the vehicle speed of the preceding vehicle 1A. Therefore, the vehicle 1 can travel smoothly from the start to the end of the left turn toward the facility of the preceding vehicle 1A.

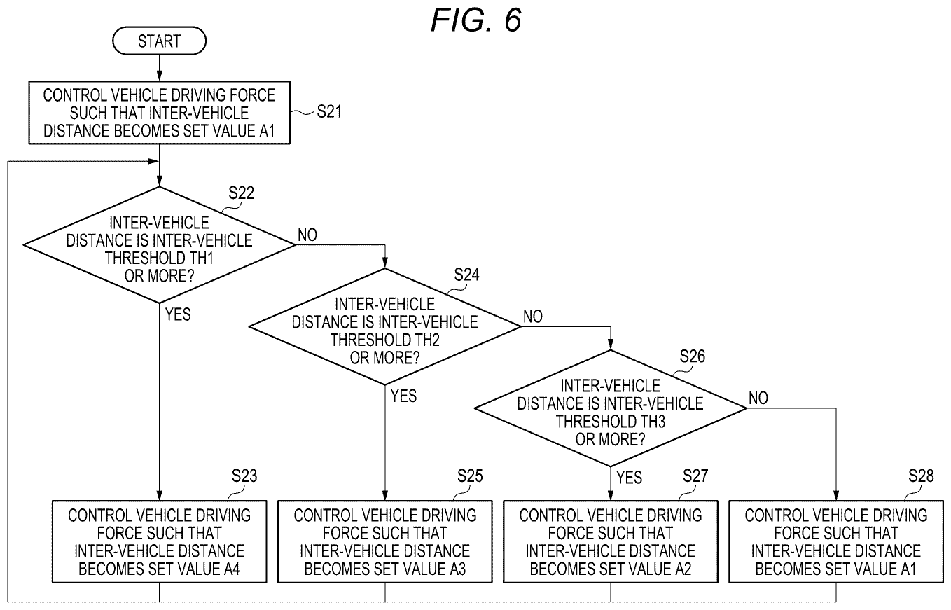

FIG. 6 is a flowchart illustrating another preferred example of the processing of the control device 30 in the following travel control. When the mode of the following travel control is set, the calculation unit 32 performs the same processing as step S1 of FIG. 2 (step S21). In step S21, it is assumed that a preceding vehicle 1A traveling at a lower speed than the vehicle 1 is recognized as a target to be followed. In step S21, it is assumed that the control value of the inter-vehicle distance L is set to the set value A1. At the time point when the processing of step S21 is started, the inter-vehicle distance L is sufficiently greater than the set value A1. Thereafter, the inter-vehicle distance L is reduced gradually.

After step S21, the calculation unit 32 obtains the inter-vehicle distance L, and determines whether the inter-vehicle distance L is equal to or greater than an inter-vehicle threshold TH1 (step S22). The inter-vehicle threshold TH1 is a value greater than the set value A1. If the determination of step S22 is YES, the calculation unit 32 controls the driving force of the vehicle 1 with the set value A4 as the control value of the inter-vehicle distance L (step S23).

If the determination of step S22 is NO, the calculation unit 32 determines whether the inter-vehicle distance L is equal to or greater than an inter-vehicle threshold TH2 (step S24). The inter-vehicle threshold TH2 is a value smaller than the inter-vehicle threshold TH1 and the set value A4 and greater than the set value A1. If the determination of step S24 is YES, the calculation unit 32 controls the driving force of the vehicle 1 with the set value A3 as the control value of the inter-vehicle distance L (step S25).

If the determination of step S24 is NO, the calculation unit 32 determines whether the inter-vehicle distance L is equal to or greater than an inter-vehicle threshold TH3 (step S26). The inter-vehicle threshold TH3 is a value smaller than the inter-vehicle threshold TH2 and the set value A3 and greater than the set value A1. If the determination of step S26 is YES, the calculation unit 32 controls the driving force of the vehicle 1 with the set value A2 as the control value of the inter-vehicle distance L (step S27).

If the determination of step S26 is NO, the calculation unit 32 controls the driving force of the vehicle 1 with the set value A1 as the control value of the inter-vehicle distance L (step S28). After step S23, step S25, step S27, and step S28, the processing returns to step S22. In parallel with the processing from step S22 illustrated in FIG. 6, the calculation unit 32 performs the processing from step S2 illustrated in FIG. 2.

If the control value of the inter-vehicle distance L set in step S21 is the set value A2, step S26 and step S28 are deleted. If the determination of step S24 is NO, the processing of step S27 is performed. If the control value of the inter-vehicle distance L set in step S21 is the set value A3, step S24, step S26, step S27, and step S28 are deleted. If the determination of step S22 is NO, the processing of step S25 is performed. If the control value of the inter-vehicle distance L set in step S21 is the set value A4, the processing of step S22, step S23, step S24, step S25, step S26, step S27, and step S28 is not performed, and the control value of the inter-vehicle distance L is maintained at the set value A4 regardless of the inter-vehicle distance.

According to the above processing, with respect to a preceding vehicle 1A traveling at a lower speed than the vehicle 1, the control value of the inter-vehicle distance L is reduced stepwise as the vehicle 1 approaches the preceding vehicle 1A, instead of rapidly reducing the inter-vehicle distance L to the set value A1 set in step S21. Therefore, if the preceding vehicle 1A starts entering the facility, the vehicle 1 can be prevented from excessively approaching the preceding vehicle 1A. As a result, the vehicle 1 as illustrated in FIGS. 3 and 4 can be controlled to approach the preceding vehicle 1A while the preceding vehicle 1A is turning left toward the facility, and the vehicle 1 can travel smoothly when the preceding vehicle 1A enters the facility.

If the processing of either FIG. 5 or 6 is to be performed, the calculation unit 32 preferably holds the control value of the inter-vehicle distance L at the default value or the set value selected by the driver (the set value A3 in the example of FIG. 5, the set value A1 in the example of FIG. 6) if the vehicle 1 is traveling on a highway or the vehicle speed of the vehicle 1 is a predetermined value or higher. In this way, the vehicle 1 can be prevented from rapid deceleration due to the control value of the inter-vehicle distance L being changed to a large value while the vehicle 1 is traveling at a high speed. This can appropriate secure the distance between the vehicle 1 and a following vehicle.

The calculation unit 32 may determine the operation state of a direction indicator of the preceding vehicle 1A. In this case, for example, even if the determination of step S2 of FIG. 2 is NO, the calculation unit 32 may determine that the preceding vehicle 1A is highly likely to enter a facility and perform the processing of step S3 if the direction indicator of the preceding vehicle 1A on the side closer to the facility (left direction indicator) continues blinking for a predetermined period of time. This enables the determination that the preceding vehicle 1A enters the facility before the preceding vehicle 1A starts to turn toward the facility.

If the vehicle 1 is to be controlled to leave the travel path (lane change control, right turn control, left turn control, or the like), the calculation unit 32 preferably holds the control value of the inter-vehicle distance L at a set value set at the start of the mode of the following travel control (the set value A3 in the example of FIGS. 2 and 5, or the set value A1 in the example of FIG. 6). In this way, for example, the inter-vehicle distance can be prevented from changing when the vehicle 1 changes lanes, thereby enabling safe lane change.

Although an embodiment of the present disclosure has been described above with reference to the accompanying drawings, it is needless to say that the present disclosure is not limited to the embodiment. It is apparent that those skilled in the art can conceive of various modifications and alterations within the scope described in the claims, and it is understood that such modifications and alterations naturally fall within the technical scope of the present disclosure. Further, the constituent elements in the embodiment described above may be combined freely in a scope not departing from the gist of the disclosure.

For example, in the above-described embodiment, a four-wheeled automobile was used as an example of the vehicle, but the present disclosure is not limited thereto. A vehicle to which the technique of the present disclosure can be applied may be a two-wheeled automobile (so-called motorcycle).

In the present description, at least the following matters are described. Although corresponding constituent elements or the like in the embodiment described above are shown in parentheses, the present disclosure is not limited thereto.

(1) A control device (control device 30) of a vehicle (vehicle 1), the control device including a processor (calculation unit 32), in which
the processor is configured to obtain a traveling angle of a preceding vehicle relative to a traveling direction of the vehicle, the preceding vehicle being followed by the vehicle, and
the processor is configured to control an inter-vehicle distance between the vehicle and the preceding vehicle based on the traveling angle.

(2) The control device according to (1), in which
in a case where the traveling angle is equal to or greater than a threshold, the processor is configured to perform control such that the inter-vehicle distance becomes smaller than the inter-vehicle distance in a case where the traveling angle is less than the threshold.

(3) The control device according to claim 2), in which
control a driving force of the vehicle such that the inter-vehicle distance becomes one of a plurality of set values, and
control the driving force of the vehicle such that the inter-vehicle distance becomes smaller than the set value set in the case where the traveling angle is less than the threshold, in a case where the traveling angle is equal to or greater than the threshold.

(4) The control device according to (3), in which
the processor is configured to perform control such that the inter-vehicle distance becomes a minimum value (set value A1) of the plurality of set values in a case where the traveling angle is equal to or greater than the threshold.

The traveling angle of the preceding vehicle of the vehicle becomes equal to or greater than the threshold if, for example, the preceding vehicle temporarily stops before a facility adjacent to the travel path and turns left from the travel path to enter the facility. According to any one of (1) to (4), in this case, the inter-vehicle distance between the vehicle and the preceding vehicle is changed to, for example, a value smaller than a preset value. Therefore, the vehicle can gradually approach the preceding vehicle while the preceding vehicle is turning left. As a result, compared to a configuration in which the control value of the inter-vehicle distance is maintained as a set value selected by the driver, the timing of re-acceleration of the vehicle can be advanced to enable natural travel control.

(5) The control device according to (4), in which
the processor is configured to perform control such that the inter-vehicle distance becomes a maximum value (set value A4) of the plurality of set values in a case where deceleration of the preceding vehicle is detected.

According to (5), the inter-vehicle distance is controlled to be the maximum value if the preceding vehicle decelerates to enter the facility. Therefore, the time for the vehicle to stop can be shortened thereafter before the preceding vehicle starts entering the facility and leaves the travel path. As a result, the vehicle can be smoothly accelerated after the preceding vehicle leaves the travel path.

(6) The control device according to (5), in which
the processor is configured to perform control such that the inter-vehicle distance becomes the maximum value in a case where the deceleration of the preceding vehicle is detected and a speed of the preceding vehicle is equal to or higher than a vehicle speed threshold, and
the processor is configured to perform control such that the inter-vehicle distance becomes a set value selected in advance (set value A3) in a case where the deceleration of the preceding vehicle is detected and the speed of the preceding vehicle is less than the vehicle speed threshold.

According to (6), if the preceding vehicle enters the facility, the inter-vehicle distance is gradually reduced in response to the deceleration of the preceding vehicle. Therefore, the vehicle can travel smoothly from the start to the end of the entry into the facility of the preceding vehicle.

(7) The control device according to (4), in which
when the preceding vehicle recognized as the target to be followed travels at a lower speed than the vehicle, the processor is configured to obtain a distance between the preceding vehicle and the vehicle, select one of the plurality of set values based on the distance, and perform control such the inter-vehicle distance becomes the selected set value.

According to (7), it is possible to gradually reduce the inter-vehicle distance between the preceding vehicle and the vehicle if the preceding vehicle is traveling while decelerating to enter the facility. Therefore, the vehicle can travel smoothly from the start to the end of the entry into the facility of the preceding vehicle.

(8) The control device according to any one of (3) to (7), in which
the processor is configured to keep a control value of the inter-vehicle distance at a set value selected in advance (set value A3) in a case where the vehicle is traveling on a highway or a case where a vehicle speed of the vehicle is equal to or higher than a predetermined value.

According to (8), the vehicle can be prevented from rapid deceleration due to the control value of the inter-vehicle distance being changed to a large value while the vehicle is traveling at a high speed. This can appropriate secure the distance between the vehicle and a following vehicle.

(9) The control device according to any one of (1) to (8), in which
the traveling angle is an angle between the traveling direction of the vehicle and a traveling direction of the preceding vehicle, or an angle of the traveling direction of the preceding vehicle relative to a lane of a travel path.

According to (9), a state in which the preceding vehicle is highly likely to enter the facility can be determined at a high accuracy.

(10) The control device according to any one of (4) to (7), in which
the processor is configured to identify how a direction indicator of the preceding vehicle operates (namely, a state of operation of a direction indicator of the preceding vehicle), and perform control such that the inter-vehicle distance becomes the minimum value in a case where the direction indicator continues blinking for a predetermined period of time.

According to (10), it can be determined earlier that the preceding vehicle enters the facility.

(11) The control device according to any one of (1) to (10), in which
the processor is configured to recognize, as the preceding vehicle, a target vehicle that is present on a predicted travel path in front of the vehicle and in a travel area within which the target vehicle is recognized as a preceding vehicle.

According to (11), the preceding vehicle can be recognized at a high accuracy.

(12) The control device according to any one of (3) to (7), in which
the processor is configured to keep a control value of the inter-vehicle distance at a set value selected in advance (set value A3) in a case where the processor performs control to cause the vehicle to leave a travel path, or in a case where the preceding vehicle changes lanes.

According to (12), the inter-vehicle distance can be prevented from being changed more than necessary, thereby enabling safe travel control.

The invention claimed is:

1. A control device of a vehicle, the control device including a processor, wherein
the processor is configured to obtain a traveling angle of a preceding vehicle relative to a traveling direction of the vehicle, the preceding vehicle being followed by the vehicle, and
the processor is configured to control an inter-vehicle distance between the vehicle and the preceding vehicle based on the traveling angle.

2. The control device according to claim 1, wherein
in a case where the traveling angle is equal to or greater than a threshold, the processor is configured to perform control such that the inter-vehicle distance becomes smaller than the inter-vehicle distance in a case where the traveling angle is less than the threshold.

3. The control device according to claim 2, wherein the processor is configured to:
control a driving force of the vehicle such that the inter-vehicle distance becomes one of a plurality of set values, and
control the driving force of the vehicle such that the inter-vehicle distance becomes smaller than the set value set in the case where the traveling angle is less than the threshold, in a case where the traveling angle is equal to or greater than the threshold.

4. The control device according to claim 3, wherein
the processor is configured to perform control such that the inter-vehicle distance becomes a minimum value of the plurality of set values in a case where the traveling angle is equal to or greater than the threshold.

5. The control device according to claim 4, wherein
the processor is configured to perform control such that the inter-vehicle distance becomes a maximum value of the plurality of set values in a case where deceleration of the preceding vehicle is detected.

6. The control device according to claim 5, wherein
the processor is configured to perform control such that the inter-vehicle distance becomes the maximum value in a case where the deceleration of the preceding vehicle is detected and a speed of the preceding vehicle is equal to or higher than a vehicle speed threshold, and
the processor is configured to perform control such that the inter-vehicle distance becomes a set value selected in advance in a case where the deceleration of the preceding vehicle is detected and the speed of the preceding vehicle is less than the vehicle speed threshold.

7. The control device according to claim 4, wherein
when the preceding vehicle recognized as the target to be followed travels at a lower speed than the vehicle, the processor is configured to obtain a distance between the preceding vehicle and the vehicle, select one of the plurality of set values based on the distance, and perform control such the inter-vehicle distance becomes the selected set value.

8. The control device according to claim 3, wherein
the processor is configured to keep a control value of the inter-vehicle distance at a set value selected in advance in a case where the vehicle is traveling on a highway or a case where a vehicle speed of the vehicle is equal to or higher than a predetermined value.

9. The control device according to claim 1, wherein
the traveling angle is an angle between the traveling direction of the vehicle and a traveling direction of the preceding vehicle, or an angle of the traveling direction of the preceding vehicle relative to a lane of a travel path.

10. The control device according to claim 4, wherein
the processor is configured to identify how a direction indicator of the preceding vehicle operates, and perform control such that the inter-vehicle distance becomes the minimum value in a case where the direction indicator continues blinking for a predetermined period of time.

11. The control device according to claim 1, wherein
the processor is configured to recognize, as the preceding vehicle, a target vehicle that is present on a predicted travel path in front of the vehicle and in a travel area within which the target vehicle is recognized as a preceding vehicle.

12. The control device according to claim 3, wherein
the processor is configured to keep a control value of the inter-vehicle distance at a set value selected in advance in a case where the processor performs control to cause the vehicle to leave a travel path, or in a case where the preceding vehicle changes lanes.
